(19) United States
(12) Patent Application Publication
(10) Pub. No.: US 2026/0116771 A1
(43) Pub. Date: Apr. 30, 2026

(54) Method for treating high-iron bauxite

(71) Applicant: ZHENGZHOU NON-FERROUS METALS RESEARCH INSTITUTE CO.LTD OF CHALCO, Zhengzhou (CN)

(72) Inventors: Guoliang WU, Zhengzhou (CN); Ke XU, Zhengzhou (CN); Xin GUO, Zhengzhou (CN); Jianqiang ZHANG, Zhengzhou (CN); Zhanyun ZHANG, Zhengzhou (CN); Le ZHANG, Zhengzhou (CN); Zhiyong ZHANG, Zhengzhou (CN); Wuxing DU, Zhengzhou (CN); Zhaobin WEI, Zhengzhou (CN); Meng ZHANG, Zhengzhou (CN)

(73) Assignee: ZHENGZHOU NON-FERROUS METALS RESEARCH INSTITUTE CO.LTD OF CHALCO, Zhengzhou, HE (CN)

(21) Appl. No.: 19/433,052

(22) Filed: Dec. 25, 2025

Related U.S. Application Data
(63) Continuation of application No. PCT/CN2023/130230, filed on Nov. 7, 2023.

(30) Foreign Application Priority Data
Jul. 17, 2023 (CN) 202310877679.1

(51) Int. Cl. C01F 7/0613

(52) U.S. Cl. CPC C01F 7/0613

(57) ABSTRACT

A method for treating a high-iron bauxite is disclosed. The method includes: subjecting a high-iron bauxite to a selective crushing treatment and a classification treatment to respectively obtain a coarse-fraction bauxite and a fine-fraction bauxite; subjecting the coarse-fraction bauxite to a first gravity separation and impurity removal treatment and a second gravity separation and impurity removal treatment to respectively obtain a gravity-separated concentrate, a gravity-separated middling, and a gravity-separated tailing; subjecting the gravity-separated concentrate to a grinding treatment and a magnetic separation treatment to respectively obtain a magnetically separated concentrate and a magnetically separated tailing; subjecting the fine-fraction bauxite to an impurity removal treatment by centrifugal separation to respectively obtain a centrifuged concentrate and a centrifuged tailing; mixing the gravity-separated middling, the magnetically separated tailing, and the centrifuged concentrate to obtain a product concentrate; and mixing the gravity-separated tailing and the centrifuged tailing to obtain a product tailing.

### CROSS-REFERENCE TO RELATED APPLICATION

This is a continuation of International Application No. PCT/CN2023/130230, filed on Nov. 7, 2023, which claims priority to Chinese Patent Application No. 202310877679.1, filed on Jul. 17, 2023. The disclosures of the above-referenced applications are hereby incorporated by reference in their entireties.

### TECHNICAL FIELD

The disclosure relates to the technical field of mineral processing, and in particular to a method for treating a high-iron bauxite.

### BACKGROUND

With a rapid development of the economy and the alumina industry, the current demand for bauxite resources in China is growing rapidly. However, China's bauxite reserves account for only 3.3% of the global reserves, and the quality is poor, far from meeting the production demand for alumina. Consequently, the demand for imported ore has been rising continuously in recent years, with a sustained growth trend. A gradual increased dependence on foreign ore exposes an alumina production in China to increasing risks.

Currently, producing alumina directly from a high-iron bauxite using the Bayer process will cause scarring in the alumina process, an increase in alkali consumption and ore consumption, thereby increasing the production cost of alumina, the amount of red mud, and affecting the quality of alumina. Therefore, it is particularly important to develop an impurity removal technology for bauxite. At present, conventional impurity removal technologies for high-iron bauxite mainly include an acid leaching and roasting process, and a magnetic separation and flotation desilication process. However, due to the high cost of these beneficiation processes and their poor adaptability to ores, the ore treatment process becomes excessively long. The current tense situation of ore supply can not be coped with, nor current economic and technical requirements of alumina enterprises for high-iron bauxite can not be met. Therefore, how to provide a method for treating a high-iron bauxite with a simple process and low cost is a technical problem that urgently needs to be solved.

### SUMMARY

By utilizing one or more embodiments of the disclosure, a technical problem in the prior art that methods for treating a high-iron bauxite have high cost and a long process is solved.

According to some embodiments of the disclosure, a method for treating a high-iron bauxite is provided. The method includes: carrying out a selective crushing treatment and a classification treatment on a high-iron bauxite to respectively obtain a coarse-fraction bauxite and a fine-fraction bauxite; carrying out a first gravity separation and impurity removal treatment, and a second gravity separation and impurity removal treatment on the coarse-fraction bauxite to respectively obtain a gravity-separated concentrate, a gravity-separated middling, and a gravity-separated tailing; carrying out a grinding treatment and a magnetic separation treatment on the gravity-separated concentrate to respectively obtain a magnetically separated concentrate and a magnetically separated tailing; carrying out an impurity removal treatment on the fine-fraction bauxite by centrifugal separation to respectively obtain a centrifuged concentrate and a centrifuged tailing; mixing the gravity-separated middling, the magnetically separated tailing, and the centrifuged concentrate to obtain a product concentrate; and, mixing the gravity-separated tailing and the centrifuged tailing to obtain a product tailing.

### BRIEF DESCRIPTION OF DRAWINGS

The drawings, which are incorporated herein and constitute a portion of this specification, illustrate embodiments consistent with the disclosure and, together with the description, serve to explain the principles of the disclosure.

To describe the technical solutions in the embodiments of the disclosure or in the prior art more clearly, the drawings required for describing the embodiments or the prior art will be briefly introduced below. Obviously, for a person skilled in the art, other drawings can be obtained based on these drawings without making any creative effort.

FIG. 1 shows a schematic flow diagram of a method for treating a high-iron bauxite according to some embodiments of the disclosure.

### DETAILED DESCRIPTION

To make the purposes, technical solutions, and advantages of the embodiments of the disclosure clearer, the technical solutions in the embodiments of the disclosure will be clearly and completely described below in conjunction with the drawings in the embodiments of the disclosure. Obviously, the described embodiments are only a portion of the embodiments of the disclosure, not all of the embodiments. Based on the embodiments in the disclosure, all other embodiments obtained by those skilled in the art without making any creative efforts shall fall within the scope of protection of the disclosure.

Unless otherwise specifically stated, various raw materials, reagents, instruments and apparatuses used in this disclosure can be purchased from the market or can be prepared by existing methods.

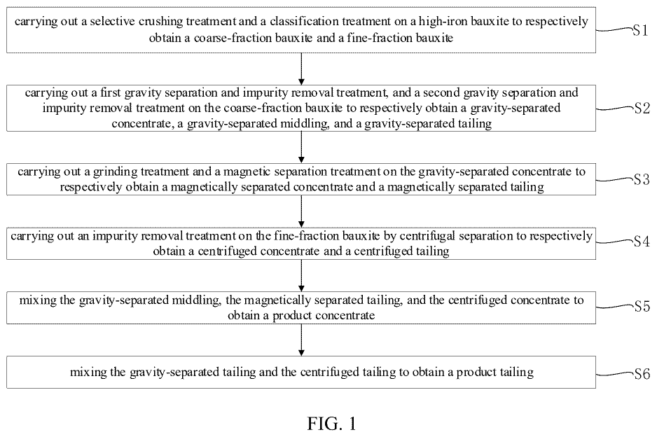

As shown in FIG. 1, a method for treating a high-iron bauxite according to some embodiments of the disclosure includes:
S1, carrying out a selective crushing treatment and a classification treatment on a high-iron bauxite to respectively obtain a coarse-fraction bauxite and a fine-fraction bauxite;
S2: carrying out a first gravity separation and impurity removal treatment, and a second gravity separation and impurity removal treatment on the coarse-fraction bauxite to respectively obtain a gravity-separated concentrate, a gravity-separated middling, and a gravity-separated tailing;
S3: carrying out a grinding treatment and a magnetic separation treatment on the gravity-separated concentrate to respectively obtain a magnetically separated concentrate and a magnetically separated tailing;
S4: carrying out an impurity removal treatment on the fine-fraction bauxite by centrifugal separation to respectively obtain a centrifuged concentrate and a centrifuged tailing;
S5, mixing the gravity-separated middling, the magnetically separated tailing, and the centrifuged concentrate to obtain a product concentrate; and,
S6, mixing the gravity-separated tailing and the centrifuged tailing to obtain a product tailing.

In some embodiments of the disclosure, valuable minerals in the high-iron bauxite are aluminum minerals (diaspore, boehmite, and gibbsite), gangue minerals are kaolinite, illite, pyrophyllite, chlorite, quartz, and calcite, and iron minerals are hematite and limonite.

In some embodiments of the disclosure, a crushing apparatus for the selective crushing treatment may include a jaw crusher and a double-roll crusher. A classification apparatus for the classification treatment may include a classifier, a hydrocyclone, a linear screen, and a high-frequency screen. The crushing apparatus may be a combination of the jaw crusher and the double-roll crusher, a crushing process may be a two-stage one-closed-circuit process, and a fraction of crushed particles with a particle size below 10 mm accounts for 100%; the classification apparatus may be a combination of the classifier, the hydrocyclone, the linear screen, and the high-frequency screen, and a particle size of classification may range from 0.074 mm to 1 mm.

In some optional embodiments, a target impurity of the first gravity separation and impurity removal treatment is a silicon mineral, a separation density of the first gravity separation and impurity removal treatment ranges from 2.2 g/cm³ to 2.8 g/cm³, and a feeding pressure of the first gravity separation and impurity removal treatment ranges from 0.1 Mpa to 0.5 Mpa.

In some optional embodiments, a target impurity of the second gravity separation and impurity removal treatment is an iron mineral, a separation density of the second gravity separation and impurity removal treatment ranges from 2.8 g/cm³ to 3.5 g/cm³, and a feeding pressure of the second gravity separation and impurity removal treatment ranges from 0.15 Mpa to 0.5 Mpa.

In some embodiments of the disclosure, by controlling the target impurity of the first gravity separation and impurity removal treatment to be the silicon mineral, and the separation density thereof to range from 2.2 g/cm³ to 2.8 g/cm³; and by controlling the target impurity of the second gravity separation and impurity removal treatment to be the iron mineral, and the separation density thereof to range from 2.8 g/cm³ to 3.5 g/cm³, and by performing the first gravity separation and impurity removal treatment and the second gravity separation and impurity removal treatment using a two-stage series-connected heavy medium cyclone, a complete separation among the gravity-separated concentrate, the gravity-separated middling, and the gravity-separated tailing can be achieved. If the separation density is lower, aluminum minerals will remain in the cleaning middlings with unliberated minerals such as silicate minerals and iron minerals, resulting in a relatively low grade of the cleaning middlings, thereby affecting a separation index.

In some embodiments of the disclosure, the heavy medium cyclone is a two-product heavy medium cyclone.

In some embodiments of the disclosure, the feeding pressures of the first gravity separation and impurity removal treatment and the second gravity separation and impurity removal treatment are controlled to range from 0.15 Mpa to 0.5 Mpa, respectively, to ensure a sufficient separation of the target impurity in the first gravity separation and impurity removal treatment and the second gravity separation and impurity removal treatment. If the feeding pressure is insufficient, a centrifugal force in the first gravity separation and impurity removal treatment and the second gravity separation and impurity removal treatment will be reduced, and thus a good separation between aluminum minerals and other impurity minerals cannot be achieved, which will affect the separation index.

In some optional embodiments, a target impurity of the impurity removal treatment is a silicon mineral, and a separation density of the impurity removal treatment ranges from 2.5 g/cm³ to 3.2 g/cm³.

In some embodiments of the disclosure, by controlling the target impurity of the impurity removal treatment to be the silicon mineral, and controlling the separation density of the impurity removal treatment to range from 2.5 g/cm³ to 3.2 g/cm³, a sufficient separation between the centrifuged concentrate and the centrifuged tailing can be achieved. Under a condition of a relatively low separation density, a portion of completely liberated silicate minerals can be only took out with the centrifuged tailing by the centrifugal separation, while unliberated minerals such as silicate minerals, aluminum minerals, iron minerals, and titanium minerals, etc., remain in the centrifuged concentrate, resulting in a relatively low grade of the centrifuged concentrate.

In some optional embodiments, a medium for the first gravity separation and impurity removal treatment and the second gravity separation and impurity removal treatment includes at least one of water, a saturated calcium chloride solution, and a sodium silicate solution, respectively; and/or,
a weighting medium for the first gravity separation and impurity removal treatment and the second gravity separation and impurity removal treatment includes magnetite powder and/or ferrosilicon, respectively; and/or,
a particle size of the magnetite powder and a particle size of the ferrosilicon are less than 0.038 mm, respectively.

In some embodiments of the disclosure, by controlling the medium for the first gravity separation and impurity removal treatment to include at least one of water, a saturated calcium chloride solution, and a sodium silicate solution, and by controlling the weighting medium for the first gravity separation and impurity removal treatment to include magnetite powder and/or ferrosilicon, a mass ratio of the medium to the weighting medium used in the first gravity separation and impurity removal treatment ranges from 1:1.5 to 1:3.0.

In some embodiments of the disclosure, by controlling the medium for the second gravity separation and impurity removal treatment to include at least one of water, a saturated calcium chloride solution, and a sodium silicate solution, and by controlling the weighting medium for the second gravity separation and impurity removal treatment to include magnetite powder and/or ferrosilicon, a mass ratio of the medium to the weighting medium used in the second gravity separation and impurity removal treatment ranges from 1:1.25 to 1:5.5.

Generally, the gravity-separated concentrate mainly contains iron minerals (hematite and limonite); the gravity-separated middling mainly contains aluminum minerals (diaspore and boehmite), and is suitable for producing alumina by the Bayer process; the gravity-separated tailing mainly contains kaolinite, illite, quartz, and calcite, and can be used as ceramic materials and building cement raw materials.

In some optional embodiments, an impurity removal medium for the centrifugal separation includes at least one of water, a saturated calcium chloride solution, and a sodium silicate solution; and/or,
a weighting medium for the centrifugal separation includes ferrosilicon; and/or,
a particle size of the ferrosilicon is less than 0.038 mm.

In some embodiments of the disclosure, by controlling the medium for the centrifugal separation to include at least one of water, a saturated calcium chloride solution, and a sodium silicate solution, and by controlling the weighting medium for the centrifugal separation to include ferrosilicon, a mass ratio between the medium and the weighting medium in the centrifugal separation ranges from 1:2.3 to 1:5.1.

An apparatus used for the centrifugal separation may be a water-jacket centrifugal machine.

Generally, the centrifuged concentrate mainly contains aluminum minerals (diaspore and boehmite), and is suitable for producing alumina by the Bayer process. The centrifuged tailing mainly contains kaolinite, illite, quartz, and calcite, and can be used as ceramic materials and building cement raw materials.

In some optional embodiments, the grinding treatment may adopt a way of wet grinding, and a weight content of ore material with a particle size ≤0.074 mm in a target bauxite for the grinding treatment is 80% to 95%.

In some embodiments of the disclosure, by controlling the weight content of the ore material with a particle size ≤0.074 mm in the target bauxite for the grinding treatment to be 80% to 95%, and by adopting the way of wet grinding, it is beneficial for achieving a better liberation between iron minerals and aluminum minerals in the bauxite, and favorable conditions for magnetic separation is provided. If the weight content of the ore material with a particle size ≤0.074 mm in the target bauxite for the grinding treatment is too large, an over-grinding phenomenon of the ore will occur, leading to the entrainment of non-magnetic minerals during the magnetic separation process, thereby affecting the yield of the magnetically separated tailing and also increasing grinding treatment energy consumption. If the weight content of the ore material with a particle size ≤0.074 mm in the target bauxite for the grinding treatment is too small, the liberation between iron-containing minerals and valuable aluminum-containing minerals is incomplete, which will lead to a poor separation effect for iron removal by magnetic separation.

In some optional embodiments, a magnetic field intensity of the magnetic separation is 0.2 T to 1.2 T, and the magnetic separation is performed 1 to 3 times.

In some embodiments of the disclosure, by controlling the magnetic field intensity of the magnetic separation to be 0.2 T to 1.2 T, and performing the magnetic separation 1 to 3 times, it is beneficial for the magnetic separation of iron-containing minerals and for reducing the iron content in the magnetically separated tailing as much as possible. If the magnetic field intensity of the magnetic separation is too large, it will lead to a reduction in the yield of the magnetically separated tailing and a loss of aluminum minerals in the magnetically separated concentrate. If the magnetic field intensity of the magnetic separation is too small, it is insufficient to achieve the separation of iron minerals and aluminum-containing minerals through magnetic separation, resulting in a relatively high iron content in the magnetically separated tailing.

In some embodiments of the disclosure, an apparatus used for the magnetic separation may include at least one of a CS-type wet electromagnetic induction roller high-intensity magnetic separator, a wet double vertical ring high-intensity magnetic separator, and an SLon-type vertical ring pulsating high-gradient magnetic separator.

In some optional embodiments, a particle size D of the coarse-fraction bauxite satisfies: n≤D≤10 mm;
a particle size d of the fine-fraction bauxite satisfies: 0 mm≤d≤n;
wherein, a value of n ranges from 0.074 mm to 1 mm.

In some optional embodiments, n is a particle size demarcation value between the coarse-fraction bauxite and the fine-fraction bauxite.

Due to complex dissemination relationships of different minerals in the bauxite, under a condition of a relatively coarse particle size, insufficient liberation of minerals leads to a relatively high aluminum-silicon ratio in the tailing and a relatively low aluminum-silicon ratio in the concentrate during the separation process, directly affecting the separation effect. In some embodiments of the disclosure, by controlling the particle size demarcation value between the coarse-fraction bauxite and the fine-fraction bauxite to be 0.074 mm to 1 mm, particle sizes of particles fed into the heavy medium cyclone and the centrifugal separator can be increased, thereby directly influencing the index of final products.

The disclosure is further described below in conjunction with specific examples. It should be understood that these examples are only used to illustrate the disclosure but are not used to limit the scope of the disclosure. The experimental methods without specific conditions indicated in the following examples are usually measured in accordance with national standards in China. If there is no corresponding national standards in China, the methods are proceeded according to general international standards, conventional conditions, or conditions recommended by the manufacturer.

### Example 1

A high-iron bauxite was selected, and the chemical composition of the high-iron bauxite included, by mass percentage, Al₂O₃: 48.51%, SiO₂: 12.56%, Fe₂O₃: 20.23%, wherein a ratio of Al:Si was 3.86.

As shown in FIG. 1, a treatment process of the method for treating the high-iron bauxite includes that:
a crushing and classification treatment were carried out on the raw ore to obtain a crushed product with a particle size smaller than 10 mm; the crushed product using 1 mm was classified as a classification standard, and a separation treatment was carried out on the crushed product with a fraction of −10 mm+1 mm by using a two-stage series-connected heavy medium cyclone under conditions where a separation density of the first gravity separation and impurity removal treatment was 2.30 g/cm³ and a separation density of the second gravity separation and impurity removal treatment was 2.90 g/cm³ to obtain a gravity-separated concentrate, a gravity-separated middling, and a gravity-separated tailing, the first gravity separation and impurity removal treatment and the second gravity separation and impurity removal treatment were configured with water and ferrosilicon respectively, feeding pressures of a first heavy medium cyclone and a second heavy medium cyclone were 0.1 MPa and 0.2 Mpa respectively;
a magnetic separation treatment was carried out on the gravity-separated concentrate using an SLon-type vertical ring pulsating high-gradient magnetic separator under conditions of a grinding fineness of 90% and a magnetic field intensity of 0.3 T, to obtain a magnetically separated concentrate and a magnetically separated tailing;
a separation treatment was carried out on the crushed product with a fraction of −1 mm by using a centrifugal separator under a condition of a heavy liquid density configured with a saturated calcium chloride solution and ferrosilicon being 2.60 g/cm³, to obtain a centrifuged concentrate and a centrifuged tailing;
the gravity-separated middling, the magnetically separated tailing, and the centrifuged concentrate were combined to form an aluminum concentrate; the gravity-separated tailing and the centrifuged tailing were combined to form a tailing; and the magnetically separated concentrate serving as an iron concentrate.

### Example 2

A high-iron bauxite was selected, and the chemical composition of the high-iron bauxite included, by mass percentage: Al₂O₃: 43.67%, SiO₂: 15.32%, Fe₂O₃: 22.18%, wherein a ratio of Al:Si was 2.85.

As shown in FIG. 1, a treatment process of the method for treating the high-iron bauxite includes:
a crushing and classification treatment were carried out on the raw ore to obtain a crushed product with a particle size smaller than 10 mm; the crushed product was classified by using 0.5 mm as a classification standard; a separation treatment was carried out on the crushed product with a fraction of −10 mm+0.5 mm by using a two-stage series-connected heavy medium cyclone under conditions where a separation density of the first gravity separation and impurity removal treatment was 2.20 g/cm³ and a separation density of the second gravity separation and impurity removal treatment was 2.80 g/cm³ to obtain a gravity-separated concentrate, a gravity-separated middling, and a gravity-separated tailing, the first gravity separation and impurity removal treatment and the second gravity separation and impurity removal treatment were configured with water and ferrosilicon respectively, feeding pressures of a first heavy medium cyclone and a second heavy medium cyclone were 0.15 MPa and 0.25 Mpa respectively;
a magnetic separation treatment was carried out on the gravity-separated concentrate using an SLon-type vertical ring pulsating high-gradient magnetic separator under conditions of a grinding treatment fineness of 85% and a magnetic field intensity of 0.5 T, to obtain a magnetically separated concentrate and a magnetically separated tailing;
a separation treatment was carried out on the crushed product with a fraction of −0.5 mm by using a centrifugal separator under a condition of a heavy liquid density configured with a saturated calcium chloride solution and ferrosilicon being 2.80 g/cm³, to obtain a centrifuged concentrate and a centrifuged tailing;
the gravity-separated middling, the magnetically separated tailing, and the centrifuged concentrate were combined to form an aluminum concentrate; the gravity-separated tailing and the centrifuged tailing were combined to form a tailing; and the magnetically separated concentrate serving as an iron concentrate.

### Example 3

A high-iron bauxite was selected, and the chemical composition of the high-iron bauxite included, by mass percentage: Al₂O₃: 41.87%, SiO₂: 14.38%, Fe₂O₃: 25.76%, wherein a ratio of Al:Si was 2.91.

As shown in FIG. 1, a treatment process of the method for treating the high-iron bauxite includes:
a crushing and classification treatment were carried out on the raw ore to obtain a crushed product with a particle size smaller than 10 mm; the crushed product was classified by using 0.2 mm as a classification standard; and a separation treatment was carried out on the crushed product with a fraction of −10 mm+0.2 mm by using a two-stage series-connected heavy medium cyclone under conditions where a separation density of the first gravity separation and impurity removal treatment was 2.5 g/cm³ and a separation density of the second gravity separation and impurity removal treatment was 3.0 g/cm³, to obtain a gravity-separated concentrate, a gravity-separated middling, and a gravity-separated tailing, the first gravity separation and impurity removal treatment and the second gravity separation and impurity removal treatment were configured with water and ferrosilicon respectively, feeding pressures of a first heavy medium cyclone and a second heavy medium cyclone were 0.1 MPa and 0.2 Mpa respectively;
a magnetic separation treatment was carried out on the gravity-separated concentrate using an SLon-type vertical ring pulsating high-gradient magnetic separator under conditions of a grinding treatment fineness of 90% and a magnetic field intensity of 0.2 T, to obtain a magnetically separated concentrate and a magnetically separated tailing;
a separation treatment was carried out on the crushed product with a fraction of −0.2 mm by using a centrifugal separator under a condition of a heavy liquid density configured with a saturated calcium chloride solution and ferrosilicon being 2.95 g/cm³, to obtain a centrifuged concentrate and a centrifuged tailing;
the gravity-separated middling, the magnetically separated tailing, and the centrifuged concentrate were combined to form an aluminum concentrate; the gravity-separated tailing and the centrifuged tailing were combined to form a tailing; and the magnetically separated concentrate serving as an iron concentrate.

### Example 4

A high-iron bauxite was selected, and the chemical composition of the high-iron bauxite included, by mass percentage: Al₂O₃: 38.47%, SiO₂: 18.21%, Fe₂O₃: 23.18%, wherein a ratio of Al:Si was 2.11.

As shown in FIG. 1, a treatment process of the method for treating the high-iron bauxite includes:

a crushing and classification treatment were carried out on the raw ore to obtain a crushed product with a particle size smaller than 10 mm; the crushed product was classified by using 0.074 mm as a classification standard; a separation treatment was carried out on the crushed product with a fraction of −10 mm+0.074 mm by using a two-stage series-connected heavy medium cyclone under conditions where a separation density of the first gravity separation and impurity removal treatment was 2.3 g/cm³ and a separation density of the second gravity separation and impurity removal treatment was 3.30 g/cm³, to obtain a gravity-separated concentrate, a gravity-separated middling, and a gravity-separated tailing, the first gravity separation and impurity removal treatment and the second gravity separation and impurity removal treatment were configured with water and ferrosilicon respectively, feeding pressures of a first heavy medium cyclone and a second heavy medium cyclone were 0.1 MPa and 0.25 Mpa respectively;
a magnetic separation treatment was carried out on the gravity-separated concentrate by using an SLon-type vertical ring pulsating high-gradient magnetic separator under conditions of a grinding treatment fineness of 85% and a magnetic field intensity of 0.2 T, to obtain a magnetically separated concentrate and a magnetically separated tailing;
a separation treatment was carried out on the crushed product with a fraction of −0.074 mm by using a centrifugal separator under a condition of a heavy liquid density configured with a saturated calcium chloride solution and ferrosilicon being 3.0 g/cm³, to obtain a centrifuged concentrate and a centrifuged tailing;
the gravity-separated middling, the magnetically separated tailing, and the centrifuged concentrate were combined to form an aluminum concentrate; the gravity-separated tailing and the centrifuged tailing were combined to form a tailing; and the magnetically separated concentrate serving as an iron concentrate.

### Comparative Example 1

Comparative Example 1 is compared with Example 1. The differences between Comparative Example 1 and Example 1 are as follows.

The composition of the high-iron bauxite in Comparative Example 1 is the same as that in Example 1.
a crushing and classification treatment was carried out on the raw ore to obtain a crushed product with a particle size smaller than 10 mm; the crushed product was classified by using 3 mm as a classification standard; subjecting the crushed product with a fraction of −10 mm+3 mm to a separation treatment using a two-stage series-connected heavy medium cyclone under conditions where a separation density of the first gravity separation and impurity removal treatment was 2.30 g/cm³ and a separation density of the second gravity separation and impurity removal treatment was 2.90 g/cm³ to obtain a gravity-separated concentrate, a gravity-separated middling, and a gravity-separated tailing, the first gravity separation and impurity removal treatment and the second gravity separation and impurity removal treatment were configured with water and ferrosilicon respectively, feeding pressures of a first heavy medium cyclone and a second heavy medium cyclone being 0.1 MPa and 0.2 Mpa respectively;
a magnetic separation treatment was carried out on the gravity-separated concentrate using an SLon-type vertical ring pulsating high-gradient magnetic separator under conditions of a grinding treatment fineness of 90% and a magnetic field intensity of 0.3 T, to obtain a magnetically separated concentrate and a magnetically separated tailing;
a separation treatment was carried out on the crushed product with a fraction of −3 mm by using a centrifugal separator under a condition of a heavy liquid density configured with a saturated calcium chloride solution and ferrosilicon being 2.60 g/cm³, to obtain a centrifuged concentrate and a centrifuged tailing;
the gravity-separated middling, the magnetically separated tailing, and the centrifuged concentrate were combined to form an aluminum concentrate; the gravity-separated tailing and the centrifuged tailing were combined to form a tailing; and the magnetically separated concentrate serving as an iron concentrate.

### Comparative Example 2

Comparative Example 2 is compared with Example 1. The differences between Comparative Example 2 and Example 1 are as follows:

The composition of the high-iron bauxite in Comparative Example 1 is the same as that in Example 1.
a crushing and classification treatment was carried out on a raw ore to obtain a crushed product with a particle size smaller than 10 mm; the crushed product was classified by using 1 mm as a classification standard; a separation treatment was carried out on the crushed product with a fraction of −10 mm+1 mm by using a two-stage series-connected heavy medium cyclone under conditions where a separation density of the first gravity separation and impurity removal treatment was 2.30 g/cm³ and a separation density of the second gravity separation and impurity removal treatment was 2.90 g/cm³, to obtain a gravity-separated concentrate, a gravity-separated middling, and a gravity-separated tailing, the first gravity separation and impurity removal treatment and the second gravity separation and impurity removal treatment being configured with water and ferrosilicon respectively, feeding pressures of a first heavy medium cyclone and a second heavy medium cyclone being 0.05 MPa and 0.15 Mpa respectively;
a magnetic separation treatment was carried out on the gravity-separated concentrate by using an SLon-type vertical ring pulsating high-gradient magnetic separator under conditions of a grinding treatment fineness of 90% and a magnetic field intensity of 0.3 T, to obtain a magnetically separated concentrate and a magnetically separated tailing;
a separation treatment was carried out on the crushed product with a fraction of −1 mm to by using a centrifugal separator under a condition of a heavy liquid density configured with a saturated calcium chloride solution and ferrosilicon being 2.60 g/cm³, to obtain a centrifuged concentrate and a centrifuged tailing;
the gravity-separated middling, the magnetically separated tailing, and the centrifuged concentrate were combined to form an aluminum concentrate; the gravity-separated tailing and the centrifuged tailing were combined to form a tailing; and the magnetically separated concentrate serving as an iron concentrate.

### Comparative Example 3

Comparative Example 3 is compared with Example 1. The differences between Comparative Example 3 and Example 1 are as follows:

The composition of the high-iron bauxite in Comparative Example 1 is the same as that in Example 1.
a crushing and classification treatment were carried out on the raw ore to obtain a crushed product with a particle size smaller than 10 mm; the crushed product was classified by using 1 mm as a classification standard; a separation treatment was carried out on the crushed product with a fraction of −10 mm+1 mm by using a two-stage series-connected heavy medium cyclone under conditions where a separation density of the first gravity separation and impurity removal treatment was 2.00 g/cm³ and a separation density of the second gravity separation and impurity removal treatment was 2.60 g/cm³, to obtain a gravity-separated concentrate, a gravity-separated middling, and a gravity-separated tailing, the first gravity separation and impurity removal treatment and the second gravity separation and impurity removal treatment were configured with water and ferrosilicon respectively, feeding pressures of a first heavy medium cyclone and a second heavy medium cyclone being 0.1 MPa and 0.2 Mpa respectively;
a magnetic separation treatment was carried out on the gravity-separated concentrate using an SLon-type vertical ring pulsating high-gradient magnetic separator under conditions of a grinding treatment fineness of 90% and a magnetic field intensity of 0.3 T, to obtain a magnetically separated concentrate and a magnetically separated tailing;
a separation treatment was carried out on the crushed product with a fraction of −1 mm by using a centrifugal separator under a condition of a heavy liquid density configured with a saturated calcium chloride solution and ferrosilicon being 2.60 g/cm³, to obtain a centrifuged concentrate and a centrifuged tailing;
the gravity-separated middling, the magnetically separated tailing, and the centrifuged concentrate were combined to form an aluminum concentrate; the gravity-separated tailing and the centrifuged tailing were combined to form a tailing; and the magnetically separated concentrate serving as an iron concentrate.

### Comparative Example 4

Comparative Example 4 is compared with Example 1. The differences between Comparative Example 4 and Example 1 are as follows:

The composition of the high-iron bauxite in Comparative Example 1 is the same as that in Example 1.
a crushing and classification treatment was carried out on the raw ore to obtain a crushed product with a particle size smaller than 10 mm; the crushed product was classified by using 1 mm as a classification standard; a separation treatment was carried out on the crushed product with a fraction of −10 mm+1 mm by using a two-stage series-connected heavy medium cyclone under conditions where a separation density of the first gravity separation and impurity removal treatment was 2.30 g/cm³ and a separation density of the second gravity separation and impurity removal treatment was 2.90 g/cm³, to obtain a gravity-separated concentrate, a gravity-separated middling, and a gravity-separated tailing, the first gravity separation and impurity removal treatment and the second gravity separation and impurity removal treatment were configured with water and ferrosilicon respectively, feeding pressures of a first heavy medium cyclone and a second heavy medium cyclone being 0.1 MPa and 0.2 Mpa respectively;
a magnetic separation treatment was carried out on the gravity-separated concentrate by using an SLon-type vertical ring pulsating high-gradient magnetic separator under conditions of a grinding treatment fineness of 80% and a magnetic field intensity of 0.15 T, to obtain a magnetically separated concentrate and a magnetically separated tailing;
a separation treatment was carried out on the crushed product with a fraction of −1 mm by using a centrifugal separator under a condition of a heavy liquid density configured with a saturated calcium chloride solution and ferrosilicon being 2.60 g/cm³, to obtain a centrifuged concentrate and a centrifuged tailing;
the gravity-separated middling, the magnetically separated tailing, and the centrifuged concentrate were combined to form an aluminum concentrate; the gravity-separated tailing and the centrifuged tailing were combined to form a tailing; and the magnetically separated concentrate serving as an iron concentrate.

### Relevant Experiments and Effect Data

The products obtained from Examples 1 to 4 and Comparative Examples 1 to 4 are compared and analyzed, and the results are shown in Table 1.

TABLE 1
Table of situations of the products obtained from the various Examples and Comparative Examples.

| | Item | | | | | | | | | | | | |
|---|---|---|---|---|---|---|---|---|---|---|---|---|---|
| | Raw Ore | | | | Concentrate | | | | Tailing | | | Iron Concentrate | |
| Group | Al₂O₃/% | SiO₂/% | Fe₂O₃/% | A/S | Yield/% | Al₂O₃/% | SiO₂/% | A/S | Al₂O₃/% | SiO₂/% | A/S | Yield/% | Fe₂O₃/% |
| Example 1 | 48.51 | 12.56 | 20.23 | 3.86 | 79.96 | 53.52 | 8.86 | 6.04 | 31.62 | 30.85 | 1.02 | 2.68 | 67.52 |
| Example 2 | 43.67 | 15.32 | 22.18 | 2.85 | 71.56 | 49.21 | 10.06 | 4.89 | 32.19 | 31.36 | 1.03 | 2.93 | 69.18 |
| Example 3 | 41.87 | 14.38 | 25.76 | 2.91 | 68.74 | 47.81 | 8.58 | 5.57 | 31.57 | 30.18 | 1.05 | 3.58 | 72.54 |
| Example 4 | 38.47 | 18.21 | 23.18 | 2.11 | 58.50 | 45.13 | 8.76 | 5.15 | 30.83 | 33.84 | 0.91 | 3.23 | 69.18 |
| Comparative | 48.51 | 12.56 | 20.23 | 3.86 | 75.41 | 51.15 | 9.45 | 5.42 | 44.71 | 24.48 | 1.83 | 2.96 | 64.52 |
| Example 1 | | | | | | | | | | | | | |
| Comparative | 48.51 | 12.56 | 20.23 | 3.86 | 85.32 | 51.91 | 9.83 | 5.28 | 31.49 | 32.17 | 0.98 | 2.12 | 62.35 |
| Example 2 | | | | | | | | | | | | | |
| Comparative | 48.51 | 12.56 | 20.23 | 3.86 | 88.65 | 51.41 | 10.97 | 4.68 | 29.89 | 33.13 | 0.90 | 3.43 | 60.16 |
| Example 3 | | | | | | | | | | | | | |
| Comparative | 48.51 | 12.56 | 20.23 | 3.86 | 78.36 | 53.92 | 8.84 | 6.10 | 31.47 | 30.92 | 1.02 | 4.28 | 58.39 |
| Example 4 | | | | | | | | | | | | | |

It can be seen from the data in Table 1 that:

Comparing data of Example 1 and Comparative Example 1, it can be seen that increasing a crushing particle size, and increasing the particle size of particles fed into the heavy medium cyclone and the centrifugal separator directly affect the final beneficiation index. This is mainly because the dissemination relationships among aluminum minerals, silicon minerals, and iron minerals in the bauxite are complex. Under a condition of a relatively coarse particle size, mineral liberation is insufficient, leading to a relatively high aluminum-silicon ratio in the tailing and a relatively low aluminum-silicon ratio in the aluminum concentrate during the separation process, thereby directly affecting the separation effect.

From the comparison of data in Example 1 and Comparative Example 2, it can be seen that reducing the feeding pressure into the heavy medium cyclone directly affects the separation index. This is mainly because insufficient feeding pressure leads to a lower centrifugal force, and thus a good separation between aluminum minerals and other impurity minerals cannot be achieved.

From the comparison of data in Example 1 and Comparative Example 3, it can be seen that reducing the separation density of the heavy medium cyclone and the centrifugal separator directly affects the separation index. This is mainly because under a condition of a relatively low separation density, diaspore remains in the aluminum concentrate with unliberated minerals such as silicate minerals and iron minerals, resulting in a relatively low grade of the aluminum concentrate.

From the comparison of data in Example 1 and Comparative Example 4, it can be seen that reducing the grinding treatment fineness and the magnetic field intensity of the magnetic separator affects the separation index of the magnetically separated concentrate and the magnetically separated tailing. This is mainly because an excessively low grinding treatment fineness leads to incomplete liberation between iron-containing minerals and valuable aluminum-containing minerals, resulting in a poor separation effect for iron removal by magnetic separation; an excessively low magnetic field intensity of the magnetic separator is insufficient to achieve a separation of iron minerals and aluminum-containing minerals through magnetic separation, resulting in a relatively low iron content in the iron concentrate.

It should be noted that the “particle size” in the disclosure can be measured as “particle diameter” and “equivalent particle diameter” depending on whether the shape of particles is spherical or not. When “particle diameter” in the disclosure is used to describe non-spherical particles, it should be understood as the “equivalent particle diameter” of the non-spherical particles. In the description of a fraction of particle size in the disclosure, a minus sign (−) before a specific numerical value indicates that the material can pass through a screen aperture of that size, and a plus sign (+) indicates that the material cannot pass through a screen aperture of that particle size. For example, “the crushed product with a fraction of −10 mm+1 mm” means “the crushed product that can pass through a screen aperture of 10 mm but cannot pass through a screen aperture of 1 mm”; “the crushed product with a fraction of −1 mm” means “the crushed product that can pass through a screen aperture of 1 mm”.

The method for treating a high-iron bauxite according to some embodiments of the disclosure has the following advantages compared with the prior art:

According to the method for treating a high-iron bauxite in some embodiments of the disclosure, a selective crushing treatment and a classification treatment are first carried out on the high-iron bauxite to obtain a coarse-fraction bauxite and a fine-fraction bauxite; a first gravity separation and impurity removal treatment and a second gravity separation and impurity removal treatment are carried out on the coarse-fraction bauxite to obtain a gravity-separated concentrate, a gravity-separated middling, and a gravity-separated tailing; then a grinding treatment treatment and a magnetic separation treatment are carried out on the gravity-separated concentrate to obtain a magnetically separated concentrate and a magnetically separated tailing; then an impurity removal treatment is carried out on the fine-fraction bauxite by centrifugal separation to obtain a centrifuged concentrate and a centrifuged tailing; then the magnetically separated tailing, the gravity-separated middling, and the centrifuged concentrate are mixed to obtain a product aluminum concentrate; the gravity-separated tailing and the centrifuged tailing are mixed to obtain a product tailing; and the magnetically separated concentrate serves as a product iron concentrate. Thus, through the above steps, the high-iron bauxite can be treated via a simple process. Meanwhile, only the selective crushing treatment, the classification treatment, the first gravity separation and impurity removal treatment, the second gravity separation and impurity removal treatment, the grinding treatment, the magnetic separation, and the centrifugal separation are needed, and the product aluminum concentrate, the product tailing, and the product iron concentrate can be obtained at a relatively low cost. Therefore, the overall method has the characteristics of a short process, low energy consumption, low production cost, low investment, and high beneficiation efficiency, and the obtained aluminum concentrate is suitable for producing alumina by the Bayer process.

In summary, the method for treating a high-iron bauxite according to some embodiments of the disclosure, based on the process flow of “crushing-classification-coarse fraction heavy medium separation desilication-magnetic separation deironing-fine fraction centrifugal separation desilication”, after treating the high-iron bauxite, can obtain a tailing with high content of silicon minerals and a relatively low aluminum-silicon ratio, as well as an aluminum concentrate with a high alumina recovery rate and an iron concentrate that can be directly sold. The method has the characteristics of a short beneficiation process, low beneficiation cost, low investment, and high beneficiation efficiency. Meanwhile, the aluminum concentrate is suitable for producing alumina by the Bayer process, the iron concentrate can be directly sold as a product, and the tailing is suitable for use as building materials and ceramic raw materials. Therefore, the utilizable resource reserves of the bauxite industry can be expanded, and the resource utilization rate of bauxite in the bauxite industry can be comprehensively improved, which is of great significance for the sustainable development of the aluminum industry at the same time.

Various embodiments of the disclosure may be presented in the form of a range; it should be understood that the description in the form of a range is merely for convenience and brevity and should not be construed as a rigid limitation on the scope of the disclosure; therefore, the description of the range should be considered as having specifically disclosed all possible sub-ranges and individual numerical values within that range. For example, the description of a range from 1 to 6 should be considered as having specifically disclosed sub-ranges, such as from 1 to 3, from 1 to 4, from 1 to 5, from 2 to 4, from 2 to 6, from 3 to 6, etc., as well as individual numbers within the stated range, such as 1, 2, 3, 4, 5, and 6, which is applicable regardless of the breadth of the range. Furthermore, whenever a numerical range is indicated herein, it is meant to include any cited number (fraction or integer) within the indicated range.

In the disclosure, unless stated otherwise, the directional terms such as “upper” and “lower” used refer specifically to the directions in the drawings. Additionally, in the description of the disclosure, the terms “comprising”, “including” and the like mean “including but not limited to”. In this document, relational terms such as “first” and “second” are only used to distinguish one entity or operation from another entity or operation. In this document, “and/or”, describing an association relationship of associated objects, indicates that three relationships may exist, for example, A and/or B may indicate: A exists alone, both A and B exist, or B exists alone. Wherein A and B may be singular or plural. In this document, “at least one” means one or more, and “a plurality of” means two or more. “At least one of”, “at least one item (piece) of the following” or similar expressions, mean any combination of these items, including a single item (piece) or a plurality of items (pieces). For example, “at least one of a, b, or c”, or “at least one of a, b, and c”, may mean: a, b, c, a-b (i.e., a and b), a-c, b-c, or a-b-c, wherein a, b, c may be single or multiple, respectively.

The above are only specific embodiments of the disclosure, enabling those skilled in the art to understand or implement the disclosure. Various modifications to these embodiments will be apparent to those skilled in the art, and the general principles defined herein may be implemented in other embodiments without departing from the spirit or scope of the disclosure. Therefore, the disclosure will not be limited to the embodiments shown herein but is to be accorded the widest scope consistent with the principles and novel features disclosed herein.

What is claimed is:

1. A method for treating a high-iron bauxite, comprising:
carrying out a selective crushing treatment and a classification treatment on a high-iron bauxite to respectively obtain a coarse-fraction bauxite and a fine-fraction bauxite;
carrying out a first gravity separation and impurity removal treatment and a second gravity separation and impurity removal treatment on the coarse-fraction bauxite to respectively obtain a gravity-separated concentrate, a gravity-separated middling, and a gravity-separated tailing;
carrying out a grinding treatment and a magnetic separation treatment on the gravity-separated concentrate to respectively obtain a magnetically separated concentrate and a magnetically separated tailing;
carrying out an impurity removal treatment on the fine-fraction bauxite by a centrifugal separation to respectively obtain a centrifuged concentrate and a centrifuged tailing;
mixing the gravity-separated middling, the magnetically separated tailing, and the centrifuged concentrate to obtain a product concentrate; and,
mixing the gravity-separated tailing and the centrifuged tailing to obtain a product tailing.

2. The method according to claim 1, wherein a target impurity of the first gravity separation and impurity removal treatment is a silicon mineral;
a separation density of the first gravity separation and impurity removal treatment ranges from 2.2 g/cm³ to 2.8 g/cm³; and
a feeding pressure of the first gravity separation and impurity removal treatment ranges from 0.1 Mpa to 0.5 Mpa.

3. The method according to claim 1, wherein a target impurity of the second gravity separation and impurity removal treatment is an iron mineral;
a separation density of the second gravity separation and impurity removal treatment ranges from 2.8 g/cm³ to 3.5 g/cm³; and
a feeding pressure of the second gravity separation and impurity removal treatment ranges from 0.15 Mpa to 0.5 Mpa.

4. The method according to claim 1, wherein a target impurity of the impurity removal treatment is a silicon mineral; and a separation density of the impurity removal treatment ranges from 2.5 g/cm³ to 3.2 g/cm³.

5. The method according to claim 1, wherein a medium for the first gravity separation and impurity removal treatment and the second gravity separation and impurity removal treatment comprises at least one of water, a saturated calcium chloride solution, and a sodium silicate solution, respectively; and/or,
a weighting medium for the first gravity separation and impurity removal treatment and a weighting medium for the second gravity separation and impurity removal treatment comprises magnetite ore and/or ferrosilicon, respectively; and/or,
a particle size of the magnetite ore and a particle size of the ferrosilicon are less than 0.038 mm, respectively.

6. The method according to claim 1, wherein an impurity removal medium for the centrifugal separation comprises at least one of water, a saturated calcium chloride solution, and a sodium silicate solution; and/or,
a weighting medium for the centrifugal separation comprises ferrosilicon; and/or,
a particle size of the ferrosilicon is less than 0.038 mm.

7. The method according to claim 1, wherein the grinding treatment comprises performing a grinding by means of wet grinding, wherein a weight content of ore material with a particle size ≤0.074 mm in a target bauxite for the grinding treatment is 80% to 95%.

8. The method according to claim 1, wherein a magnetic field intensity for the magnetic separation is 0.2 T to 1.2 T; and the magnetic separation is performed 1 to 3 times.

9. The method according to claim 1, wherein a particle size D of the coarse-fraction bauxite satisfies: n≤D≤10 mm;
a particle size d of the fine-fraction bauxite satisfies: 0 mm≤d≤n;
wherein, a value of n ranges from 0.074 mm to 1 mm.

10. The method according to claim 9, wherein n is a particle size demarcation value between the coarse-fraction bauxite and the fine-fraction bauxite.
